(19) United States
(12) Patent Application Publication
(10) Pub. No.: US 2011/0074666 A1
(43) Pub. Date: Mar. 31, 2011

(54) REMOTE CONTROL SYSTEM FOR MULTI-SCREEN DISPLAY

(75) Inventors: YI LO, Tu-Cheng (TW); ZHI-LAN SHI, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/647,989

(22) Filed: Dec. 28, 2009

(30) Foreign Application Priority Data
Sep. 30, 2009 (CN) 200910307993.6

(51) Int. Cl. G09G 5/00

(52) U.S. Cl. 345/156; 398/106

(57) ABSTRACT

A remote control system for a multi-screen display of an array of sub-displays tiled together contiguously includes a remote controller and a number of control boxes each of which is installed on a corresponding sub-display. The remote control is configured for receiving user input governing selection and control of the sub-displays, generating a control signal based upon the selection and the control of the sub-displays, and transmitting the control signal. Each control box is configured for receiving the control signal, identifying if the control signal is passed and transferred to a controller of corresponding sub-displays upon the selection of the sub-displays.

### BACKGROUND

1. Technical Field

This present disclosure relates to remote control systems and, particularly, to a remote control system providing control of a sub-display of a multi-screen display.

2. Description of Related Art

Multi-screen displays (or video walls) of an array of sub-displays may improve clarity, wide visibility, and enhance detail of images. To facilitate control of such a multi-screen display, each of the sub-displays is installed with a receiver and a remote controller having a transmitter. As such, the multi-screen display can be controlled by the remote controller via communication between the transmitter and the receiver. However, it is difficult or inconvenient to control a specific sub-display or certain portion of sub-displays of the multi-screen display using such a current remote control system.

Therefore, it is desirable to provide a remote control system for a multi-screen display, which can overcome the above-mentioned problems.

### BRIEF DESCRIPTION OF THE DRAWINGS

FIG. 1 is a schematic view of a remote control system for a multi-screen display, according to an exemplary embodiment.

FIG. 2 is a functional block diagram of the remote control system of FIG. 1.

### DETAILED DESCRIPTION

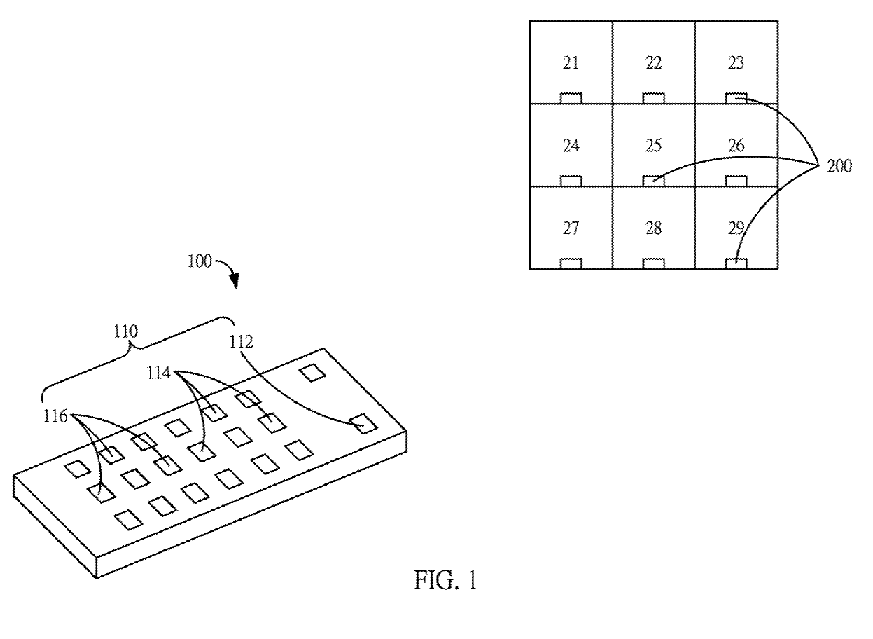

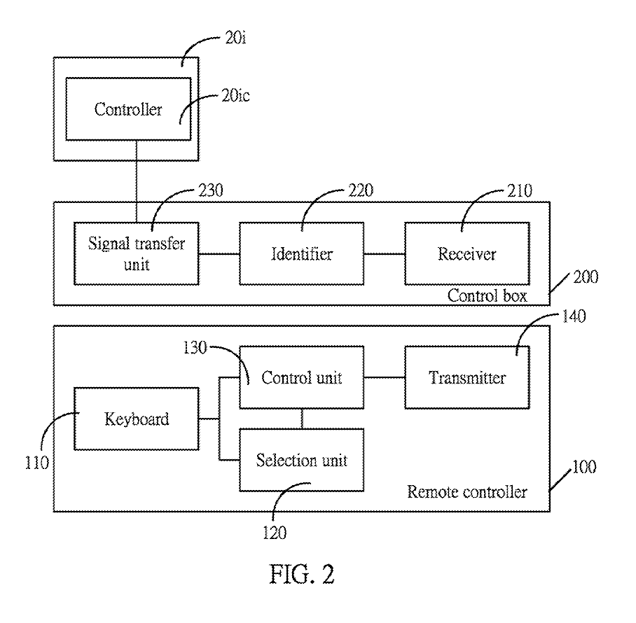

Referring to FIGS. 1-2, a remote control system 10 for a multi-screen display 20, according to an exemplary embodiment, includes a remote controller 100 and a number of control boxes 200. The multi-screen display 20 comprises an array of sub-displays 20i (where i is a positive integral number and represents an ith sub-display) tiled together contiguously. The sub-displays 20i can be cathode ray tube (CRT) displays, liquid crystal displays (LCDs), light emitting diode (LED) displays, plasma displays, for example. Each of the control boxes 200 is installed on a corresponding sub-display 20i typically at the bottom edge thereof. In this embodiment, a 3×3 array of sub-displays 21˜29 is employed; however, it may be understood that other arrays of varying numbers of sub-displays may be employed without departing from the spirit of the disclosure.

The remote controller 100 includes a keyboard 110, a selection unit 120, a signal generation unit 130, and a transmitter 140.

The keyboard 110 receives user input, and can, for example, include a power control 112, a number of selection controls 114, and a number of parameter controls 116. The power control 112 is configured for receiving a first user input representative of turning a corresponding sub-display 20i or certain portions of the sub-displays 20i on and off. The selection controls 114 receive a second user input representative of a selection of a corresponding sub-display 20i or certain portion of sub-displays 20i. The parameter controls 116 are configured for receiving a third user input representative of a parameter to change configuration of a corresponding sub-display 20i or certain portion of sub-displays 20i, such as brightness, contrast, and/or volume adjustment.

However, the layout of the keyboard 110 is not limited to this embodiment. For example, in other alternative embodiments, the selection controls 114 can be omitted, and the selection of a specific sub-display 20i or portion of sub-displays 20i can be realized by a combination of parameter controls 116. Also, the embodiment is not limited to use of the keyboard 110, and any input device or means capable of receiving user input can be employed, such as a touch screen, for example.

The selection unit 120 is coupled to the keyboard 110 and configured for generating a selection signal, such as a code that is representative of a selection of a corresponding sub-display 20i or portion of sub-displays 20i based upon the second user input via the selection controls 114.

The signal generation unit 130 is coupled to the keyboard 110 and configured for generating a control signal representative of a control of a corresponding sub-display 20i or certain portion of sub-displays 20i based upon the selection signal and the first user input via the power control 112 and the third user input via the parameter controls 116. For example, the signal generation unit 130 receives a signal triggered by the power control 112 or the parameter controls 116 and modulates the signal with the selection signal to produce the control signal. However, it should be understood that the selection unit 120 and the signal generation unit 130 can be integrated in other alternative embodiments.

The transmitter 140 is coupled to the signal generation unit 130 and configured for transmitting the control signal using, for example, infrared (IR) technology.

It should be understood that, in practice, the remote controller 100 may further include a housing (not shown) that accommodates the components thereof and a power source (not shown), such as a battery.

Each of the control boxes 200 includes a receiver 210, an identifier 220, and a signal transfer unit 230.

The receiver 210 is configured for receiving the control signal from the transmitter 140.

The identifier 220 is configured for determining if the control signal should be relayed to the signal transferring unit 230, and may include a read only memory (ROM) in which a predetermined code is stored. The identifier 220 compares the code modulated in the control signal with the predetermined code. If the two codes match, the control signal is passed on to the signal transfer unit 230. Otherwise, the control signal is blocked. A portion of sub-displays 20i corresponding to the identifiers 200 having the same code can be controlled by the same control signal.

The signal transfer unit 230 is configured for transferring the control signal to a controller 20ic of the corresponding sub-display 20i or controllers 20ic of certain portion of sub-displays 20i. As such, the controller(s) can execute the control signal to control the sub-display(s) 20i.

It should be understood that, in practice, each of the control boxes 200 may further include a housing for accommodating the components thereof and a power source, such as a battery (or be powered by the sub-display 20i). Also, each of the control boxes can be integrated into a corresponding sub-display 20i.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A remote control system for a multi-screen display that comprises an array of sub-displays tiled together contiguously, the control system comprising:
a remote controller, comprising:
an input unit that receives user input representative of a selection and a control of the sub-displays;
a signal generation unit configured for generating a control signal based upon the selection and the control of the sub-displays; and
a transmitter configured for transmitting the control signal; and
a plurality of control boxes, each installed on a corresponding sub-display and comprising:
a receiver receiving the control signal;
an identifier; and
a signal transfer unit; the identifier being configured for determining if the control signal is passed to the signal transfer unit; the signal transfer unit being configured for transferring the control signal to a controller of the corresponding sub-display for control.

2. The remote control system of claim 1, wherein each of the sub-displays is selected from the group consisting of: a cathode ray tube (CRT) display, a liquid crystal display (LCD), a light emitting diode (LED) display, and a plasma display.

3. The remote control system of claim 1, wherein the input unit comprises a power control configured for receiving a user input representative of turning corresponding sub-display(s) on and off.

4. The remote control system of claim 1, wherein the input unit comprises at least one selection control configured for receiving a user input representative of a selection of corresponding sub-display(s).

5. The remote control system of claim 1, wherein the user input comprises at least one parameter control configured for receiving a user input representative of a parameter to change configuration of corresponding sub-display(s).

6. The remote control system of claim 5, wherein the parameter is selected from the group consisting of brightness, contrast, and volume.

7. The remote control system of claim 1, wherein the signal generation unit comprises a selection unit, the selection unit being coupled to the input unit and configured for generating a selection signal representative a selection of corresponding sub-display(s).

8. The remote control system of claim 7, wherein the selection signal comprises a code of a selection of corresponding sub-displays.

9. The remote control system of claim 7, wherein the signal generation unit is configured for generating a control signal representative of a control of corresponding sub-display(s) within which the selection signal is modulated.

10. The remote control system of claim 1, wherein the transmitter is an infrared transmitter.

11. The remote control system of claim 1, wherein the control signal comprises a code of a selection of corresponding sub-displays, the identifier comprising a predetermined code and being configured for comparing the predetermined code with the code of the control signal, the control signal being relayed if the two codes match.
